(19) United States
(12) Patent Application Publication
(10) Pub. No.: US 2009/0104360 A1
(43) Pub. Date: Apr. 23, 2009

(54) Method for manufacturing a visual communication panel

(76) Inventor: Leo Albert Julia Gypen, Zonhoven (BE)

Correspondence Address: BACON & THOMAS, PLLC, 625 SLATERS LANE, FOURTH FLOOR, ALEXANDRIA, VA, 22314-1176, US

(21) Appl. No.: 11/920,257

(22) PCT Filed: May 11, 2006
(86) PCT No.: PCT/BE2006/000050

§ 371 Date: Nov. 13, 2007

(30) Foreign Application Priority Data
May 13, 2005 (BE) 2005/0244

(51) Int. Cl. B05D 3/02; B05D 3/00

(52) U.S. Cl. 427/372.2; 427/331

(57) ABSTRACT

Method for manufacturing a visual communication panel which mainly consists of a support (2) onto which is provided a coat of porcelain or vitreous enamel (4), characterised in that a sol-gel dispersion is provided on the visible side of the coat of porcelain or vitreous enamel (4) which is subsequently tempered so as to form a mainly glassy or ceramic cover layer (5).

The present invention concerns a method for manufacturing a visual communication panel, in particular a panel with an porcelain or vitreous enameled surface which is designed to be written on with dry, erasable felt-tip pens or to be used as a projection screen.

Known communication panels usually consist of a support made of a wood fibre board, a paper honeycomb structure, a synthetic or the like onto which is fixed a metal plate having a coat of enamel on it, on the visible side of the panel.

The back of the panels is either or not provided with a supporting plate and/or a foil which can serve as a damp-proof guard.

A disadvantage of such panels is that the coat of enamel is usually relatively smooth and hence glares, in order to be easily wipeable for felt-tip pens, such that annoying light reflections may occur due to incident light of lamps or the like, and as a result of which spectators can hardly or not see what is being written or projected on the panel.

Matt enameled panels which are designed as a projection screen or as a board to be written on with dry, erasable felt-tip pens, have less annoying light reflections than their glossy variants, but they are more difficult to wipe in a dry manner.

Organic visual communication panels made of lacquered steel are usually far less scratch-resistant, wear-resistant and hence have a shorter life compared to the above-mentioned enameled panels.

The present invention aims to remedy the above-mentioned and other disadvantages.

To this end, the invention concerns a method for manufacturing a visual communication panel which mainly consists of a support onto which is provided a coat of enamel, whereby a sol-gel dispersion is provided on the visible side of the coat of porcelain or vitreous enamel which is then tempered in order to form a mainly glassy or ceramic cover layer.

An advantage of the method according to the invention is that it makes it possible to manufacture communication panels with a relatively large hardness and resistance to wear, possibly even much larger than that of the above-mentioned organic visual communication panels.

The above-mentioned dispersion preferably also contains particles in an order of magnitude which is larger than the wavelength of visible light.

This preferred method offers the additional advantage that the glare of the thus obtained communication panels is relatively low.

Indeed, by providing the above-mentioned particles in the cover layer on the coat of enamel, the incident light on the panel is diffused, such that the glare of the panel is reduced, and annoying light reflections of lamps and the like are restricted.

According to yet another preferred method, the above-mentioned dispersion contains fluorine containing products.

Adding fluorine containing products to the above-mentioned dispersion offers the advantage that the surface tension of the finished cover layer is relatively low, as a result of which the ink of felt-tip pens or the like can be removed relatively easily from the cover layer in a dry manner.

According to a further preferred method, the thickness of the sol-gel coat is designed to be equal to one fourth of the wavelength of visible light, resulting in a sol-gel thickness of between 75 and 180 nanometres.

In this way the sol-gel coat forms a quarter wavelength anti-reflection layer. Indeed, a first portion of the visible light that hits the communication panel is reflected by the external surface of the sol-gel coat, and a second portion of the visible light is reflected by the interface between the sol-gel coat and the porcelain or vitreous enamel. As the thickness of the sol-gel coat equals one fourth of the wavelength of visible light, both reflected waves are out of phase by 180° or π radians, and as a consequence they at least partially cancel each other.

By preference the sol-gel coating should have an index of refraction that is smaller than the index of refraction of the porcelain or vitreous enamel.

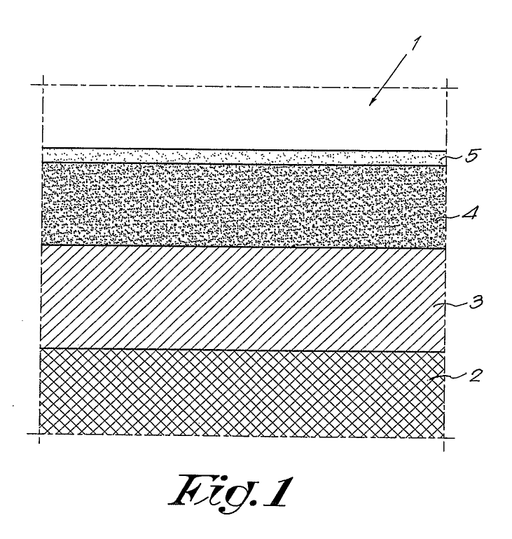

In order to better explain the characteristics of the present invention, the following preferred method according to the invention for manufacturing a visual communication panel is given as an example only without being limitative in any way, with reference to the sole accompanying FIG. 1, in which is represented a cross-section of a communication panel made according to a method of the invention.

FIG. 1 represents a visual communication panel 1 which mainly consists of a support 2, onto which is fixed a metal or steel plate 3 which is provided with a coat of porcelain or vitreous enamel 4.

This coat of enamel 4 may consist of one or several layers, such as for example a first layer of enamel which adheres well to the above-mentioned metal plate or steel plate 3, and a top layer of enamel with the required properties such as for example a required colour.

The above-mentioned support 2, metal plate 3 and coat of enamel 4 are generally known in the domain of visual communication panels 1, and therefore they will not be further described in detail here.

According to the invention, a glassy or ceramic cover layer with a thickness of preferably some 3 micrometers is provided on the above-mentioned coat of enamel 4.

This cover layer 5 is formed by providing what is called a sol-gel dispersion on the coat of enamel 4 and by subsequently tempering the dispersion at a temperature situated between 200° and 600° C., and which preferably amounts to some 510° C.

The above-mentioned sol-gel dispersion is hereby defined as a usually colloidal solution of inorganic metal salts and/or organic metal compounds, such as metal alcoxides, whereby this solution or, more particularly, liquid dispersion is transformed in what is called a ‘sol’ state during a drying process, and forms the above-mentioned cover layer after some tempering.

The sol-gel dispersion is hereby preferably prepared from a basic solution of metal alcoxydes onto which are preferably added an aqueous colloidal silica solution and/or particles of metal oxide and/or fluorine containing products.

Examples of useful metal alcoxydes are among others: tetra methoxy silane [Si(OCH₃)₄]; tetra ethoxy silane [(Si(OC₂H₅)₄]; methyl triethoxy silane [Si(OCH₃)(OC₂H₅)₃]; tetra ethoxy titanium [Ti(OC₂H₅)₄]; tetra propyl oxide titanium [Ti(OC₃H₇)₄]; tetra butoxy titanium [Ti(OC₄H₉)₄]; tetra propyl oxide zirconium [Zr(OC₃H₇)₄].

The above-mentioned colloidal silica solution consists of an aqueous dispersion with silicon oxide particles in an order of magnitude of 5 to 100 nm, whereas the above-mentioned particles of metal oxides have dimensions which are at least larger than the wavelength of visible light and which are preferably situated between 1 and 3 micrometers.

The above-mentioned particles of metal oxides, ordered here according to their increasing index of light refraction, consist for example of silicon oxide, zirconium oxide and/or titanium oxide.

A practical example of a useful basic solution consists of:
65 mole percent of methyl triethoxy silane;
15 mole percent of tetra ethoxy silane;
10 mole percent of tetra butyl ortho titanate; and
10 mole percent of tetra propyl zirconate.

By means of the above-mentioned basic solution, an above-mentioned sol-gel dispersion can be prepared which is composed of:
63 mass percent of the above-mentioned basic solution;
10 mass percent of colloidal silica solution (e.g. K40 of “Chemiewerk Bad Köstritz”);
24 mass percent of particles of metal oxides, of which:
   16 mass percent of silicon oxide;
   4 mass percent of titanium oxide;
   4 mass percent of zirconium oxide; and
   3 mass percent of ammonium fluorine.

This sol-gel dispersion is subsequently provided on the above-mentioned coat of enamel 4, after which the dispersion is transformed in a solid gel or what is called a ‘sol’ under the influence of heat which, after a drying process at some 95° C. and the tempering thereof up to 510° C., forms the required glassy or ceramic cover layer 5.

The above-mentioned sol-gel dispersion can be provided on the coat of enamel 4, for example by immersing the coat of enamel 4 in the dispersion; by spraying the dispersion over the coat of enamel 4; by means of silkscreen printing; by what is called roll coating or the like.

It should be noted that the above-mentioned particles of metal oxides can be traced as such in the formed cover layer 5, and have a light-diffusing effect in there, such that annoying light reflections by the visual communication panel can be minimized.

The present invention is by no means limited to the above-described method; on the contrary, such a method according to the invention for manufacturing a visual communication panel can be made according to different variants while still remaining within the scope of the invention.

1. Method for manufacturing a visual communication panel which includes a support onto which is provided a coat of porcelain or vitreous enamel, comprising the steps: providing a sol-gel dispersion on a visible side of the coat of porcelain or vitreous enamel and subsequently tempering the dispersion so as to form a glassy or ceramic cover layer on the porcelain or enamel coat.

2. Method according to claim 1, including distributing particles of metal oxides in the dispersion, said particles having dimensions which are larger than the wavelength of visible light.

3. Method according to claim 2, wherein the particles are on the order of magnitude between 1 and 3 micrometers in size.

4. Method according to claim 2, wherein the particles comprise particles selected from the group of silicon oxide, titanium oxide and zirconium oxide, or any combination thereof.

5. Method according to claim 1, wherein the dispersion includes an amount of colloidal silica.

6. Method according to claim 5, wherein the colloidal silica comprises silicon oxide particles having a size on the order of magnitude of 5 to 100 nanometres.

7. Method according to claim 1, wherein the sol-gel dispersion includes fluorine containing products.

8. Method according to claim 1, wherein the tempering is carried out at a temperature between 200 and 600° C.

9. Method according to claim 1, wherein the thickness of the sol-gel coat is arranged to be equal to one fourth of the wavelength of visible light, resulting in a sol-gel thickness of between 75 and 180 nanometres.
